(19) United States
(12) Patent Application Publication
(10) Pub. No.: US 2015/0294373 A1
(43) Pub. Date: Oct. 15, 2015

(54) Data Acquisition and Management System for Advertisement and Retail Use

(71) Applicant: Daniel D. Schuh, Knoxville, TN (US)

(72) Inventor: Daniel D. Schuh, Knoxville, TN (US)

(21) Appl. No.: 14/248,578

(22) Filed: Apr. 9, 2014

(51) Int. Cl. G06Q 30/02; G06K 9/00; G06Q 20/20

(52) U.S. Cl. CPC G06Q 30/0276; G06Q 30/0255; G06Q 30/0269; G06Q 20/20; G06K 9/00812

(57) ABSTRACT

A computer-implemented system for generating advertisements based on data. The system includes a computer equipped with image recognition software, a parking area, a ticket generator that issues tickets having ticket codes for the parking area, a camera that captures image data at the time the ticket is issued and that communicates that data to the computer. The computer applies image recognition software to the image data to obtain consumer data. The computer generates an electronic profile for consumers that associate the consumer with a ticket code, image data and consumer data. The computer selects an advertisement based on data associated with the profile, which is then delivered to the consumer.

### FIELD

This invention relates to advertising. More particularly, this invention relates to a system for generating advertisements based, at least in part, on information collected during consumers' interactions with a controlled parking area.

### BACKGROUND

The traditional shopping model has evolved over time and, importantly, advertising methods have also changed. Among these changes is a demand for greater accountability of advertisers by vendors for their advertising dollars. While online shopping is becoming more common, a majority of goods are still purchased locally, and, by their nature, most service jobs are provided locally. The greatest shift in goods purchases has been away from small businesses to corporate or “big box” retailers. This has also shifted purchases away from central business districts (CBD), often referred to as “downtown,” in the heart of cities and towns to outlying singular locations with dedicated parking lots that are available to customers free of charge. As such, locations with limited, pay-for-use parking have seen the greatest loss of retail and service businesses.

Small businesses rely on highly-local consumers, especially those in high-density areas to support and maintain their business. One reason for this is proximity. Consumers that live or work near these businesses are most likely to be their most consistent customer. Targeting these consumers with advertising, therefore, is very important for the continued success of these businesses. However, many communities have banned billboards and have limited the use of signage in the CBD, so businesses need another advertising method to reach their most-likely customers.

At the same time, cities need an effective yet economical method for ensuring that consumers continue to provide their patronage and to support businesses. The decline of retail and service businesses in high-density districts has been attributed to the cost of parking. As suburbanization spread the population to outlying areas, consumers were lured away with “free” parking. In actuality the cost of this parking was often subsidized by the developer and, in many cases, the city government through tax incentives, which encouraged the sprawl.

This type of “suburban growth” changed consumers' shopping habits and caused a decline in the high-density urban core. Communities responded by offering incentives to retain businesses through subsidized municipal parking garages and lots. Many communities still offer free and subsidized parking, but shrinking municipal budgets and low returns on the investment have threatened this subsidy and the economic progress it provides.

The “traditional” model of shopping was based around districts where consumers could find goods and services within a walkable distance from their homes at a collection of brick and mortar stores. As suburbanization spread the population, these districts became less defined and consumers' shopping habits changed. As a result of these changes, traditional media outlets such as television, radio and print, which had traditionally been popular and cost effective methods for advertising, began to lose their effectiveness and appeal for small businesses.

Traditional media marketing philosophy is a shotgun approach, where vendors advertised their business as much as possible to any and all consumers. Using this method, it was assumed that many potential customers would see the advertisement, but only a portion of those potential customers would become actual customers. Vendors relied on volume and repetition to reach its customers. While this method worked fairly well for small business when communities were concentrated and shopping districts were well defined, it has become less effective as the traditional shopping model dissolved. Nonetheless, it is still effective for big business with large advertising budgets.

Another problem for traditional media is proof of effectiveness. Marketers primarily rely on anecdotal evidence to justify their effectiveness. For example, advertisements for a marketer might state “Bob's sales have shot through the roof since he started advertising with us.” Additionally, statements such as “tell them you heard about it from us” are often not reliable. Instead, coupons, which people redeem in person, have been the most reliable means to know the advertisement is working.

The advent of the Internet and personal hand-held computing devices has changed consumers' habits again. Consumers can purchase goods from anywhere in the world and get their information from a wide variety of sources. The Internet has created a global economy and has created new competition across all “local” markets, urban and suburban. At the same time it broadened advertisers available choices.

Internet advertising brought increased consumer data, which has allowed advertisers to target their market more effectively and to receive feedback on the effectiveness of their advertising. These are two things that traditional media outlets have struggled to do.

Internet advertising can track consumers' activities, including recent product searches, purchase history, and some locational information. It allows advertisers to fairly reliably target people looking for a good or service, but the information is still not definite in certain instances such as when location tracking or cookies are disabled. Without reliable locational information, advertisements might be wasted on consumers who are located far away from the vendor and that would never shop at the vendor's brick and mortar location. Additionally, relying on Internet advertising requires the potential customer to actively search the Internet in order to receive the information, or access a website that indirectly advertises along side the webpage content in much the same way traditional media works.

A problem with TV, radio and Internet advertisements is that they are temporal. They exist only as long as they are broadcast or displayed. They rely on the consumer to remember the advertisement. Advertisers use jingles, slogans, and repetition to try to “imprint” the advertisement onto the mind of their potential customers. However if the customer is not paying attention and later wants to recall the advertisement, it is often not possible. Print media has the advantage of recall. The consumer can clip the coupon or flip through the pages and see the advertisement again. In this way print media has longevity and increased effectiveness over more intangible advertising means, such as TV, radio or Internet advertisements.

What is needed therefore, is a system that is able to encourage consumers to return to shopping locally, where parking is limited, and a method for businesses to actively target consumers with advertising at those locations. This system preferably encourages shoppers by transferring the cost of parking while creating revenues for operating the parking facilities that are based on direct advertising and alternative payment options that are based on consumer spending activity. The system needs to geographically locate consumers, track their spending habits, and offer incentives to return for repeat business both virtually and in a printed form.

### SUMMARY

The above and other needs are met by a computer-implemented system for generating advertisements based on data. The system includes a computer having a data processor, a memory, a computer application including image recognition software, and a database containing advertisement data, vendor data, consumer data, and image data, all stored to the memory. The system further includes a parking area having a drive-though area or portal through which vehicles may pass. A first camera is located near the portal and is configured to capture image data, which may include one or more of still photographs or videos. The image data is created at the time of and in response to a vehicle being located in the portal. The first camera is further configured to communicate the image data to the computer. A ticket generator is configured to issue a ticket having a machine-readable code to a parking area consumer and to communicate each ticket code to the computer. The computer is configured to associate each ticket code with image data that were created when the ticket was issued. Electronic profiles are created and are associated with consumers that use the parking area, and each profile is stored to the consumer database. The application applies the image recognition software to the image data to obtain consumer data, which it then stores to the electronic profiles in association with the consumers and the ticket codes. Based on data associated with an electronic profile for a parking area consumer, the computer is configured to select one of a plurality of advertisements and to transmit delivery commands requesting delivery of the selected advertisement to the parking area consumer. The system may optionally include a display screen for receiving the delivery commands and for delivering the selected advertisement to the parking area consumer.

The system may include a point-of-sale (POS) terminal in communication with the computer that is operable for carrying out an interaction between a consumer and a vendor. The POS terminal is configured to receive consumer information from the parking area consumer and to communicate that consumer information to the computer. The computer is configured to identify the electronic profile associated with the parking area consumer by comparing the consumer information received from the parking area consumer with data associated with the electronic profiles. The POS terminal is further configured to communicate vendor data to the computer at the time of the interaction with the parking area consumer. The computer then associates the vendor data received with the identified profile. In certain embodiments, the POS terminal is a vendor ticket machine programmed to read the code on a ticket, and the consumer information communicated by the POS terminal to the computer includes the ticket code. The POS terminal may be located at a vehicle drive-through area and may be accessed by the parking area consumer from a vehicle located in the drive-through area. In certain embodiments, the vendor data may include the items purchased by the consumer using the POS terminal, the time of the purchase, the date of the purchase, or the purchase price.

In certain embodiments, the system may include an exit ticket reader and a fee-based exit control device located at the drive-through area of the parking area. The control device regulates the exit of vehicles from the parking area, assesses a fee in response to a ticket being scanned at the exit ticket reader, and permits the vehicle to exit the parking area in response to receiving payment of the assessed fee. The vendor data may include a credit to reduce the parking fee that is associated with the selected profile. If so, when the consumer scans the ticket at the exit ticket reader, the computer applies the credit to reduce the parking fee by sending instructions to the fee-based exit control device to permit the vehicle to exit the parking area after receiving payment of a reduced fee. The consumer may optionally select to apply at least a portion of the credit and to pay a reduced fee or to not apply the credit and pay the assessed fee.

The system may further include a second camera located proximate the POS terminal that is configured to capture image data. The image data is created at the time of and in response to a consumer accessing the POS terminal. The second camera is configured to communicate the image data to the computer. The application applies the image recognition software to the image data to obtain consumer data and the computer compares that consumer data with consumer data stored in the computer to identify the consumer.

The consumer data may include the make and model of a vehicle located at the drive-through area, the license plate number of the vehicle located at the drive-through area, the gender of an occupant of the vehicle located at the drive-through area, or the identity of an occupant of the vehicle located at the drive-through area.

In certain embodiments, the system includes a third camera located proximate the drive-through area configured to capture image data. The image data is created at the time of and in response to vehicles being located in the drive-through area of the parking area. The third camera sends the image data to the computer, where the application applies the image recognition software to the image data to obtain consumer data. The consumer data is then stored to electronic profiles in association with the consumers and the ticket codes. The consumer data obtained from the third camera is different from the consumer data obtained from the image data of the first camera.

The system may include a mobile device selected from the group consisting of a mobile computer, a mobile tablet, and a mobile phone, the mobile device. The mobile device includes an application enabling it to communicate with the computer and to transmit consumer data to the computer. The mobile device also preferably includes a display screen for displaying the selected advertisement.

Further details of each of these and other embodiments of the invention are provided in the drawings and in the detailed description.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 is a block diagram depicting one embodiment of a data acquisition and management system for advertisement and retail use;

FIG. 2 is a block diagram detailing the computer used in the data acquisition and management system for advertisement and retail use shown in FIG. 1;

FIG. 3 is a block diagram detailing the parking area of the data acquisition and management system for advertisement and retail use shown in FIG. 1; and

FIG. 4 is a block diagram detailing the shopping area of the data acquisition and management system for advertisement and retail use shown in FIG. 1.

### DETAILED DESCRIPTION

The following detailed description provides various embodiments of a computerized system for gathering data on consumers, for storing the data in a consumer database and for analyzing that data using a software application. Using the stored data and the analysis of that data, the system provides a variety of advertisements, discounts, promotions, etc., generally referred to herein as advertisements to those consumers.

One purpose of this system is to encourage consumers to make purchases from a vendor at their brick-and-mortar locations, such as diners, clothing stores, movie theatres, etc. By providing consumers with free parking, coupons, and other discounts and incentives, they are more likely to shop at those brick and mortar locations. At the same time, the system is designed to minimize costs of maintaining a free or subsidized parking area by not providing those same incentives (i.e., free parking) to consumers that do not make purchases with the vendor. Another purpose of this system is to further encourage or modify consumers' purchase behavior by providing advertising based on data collected by the system on that consumer.

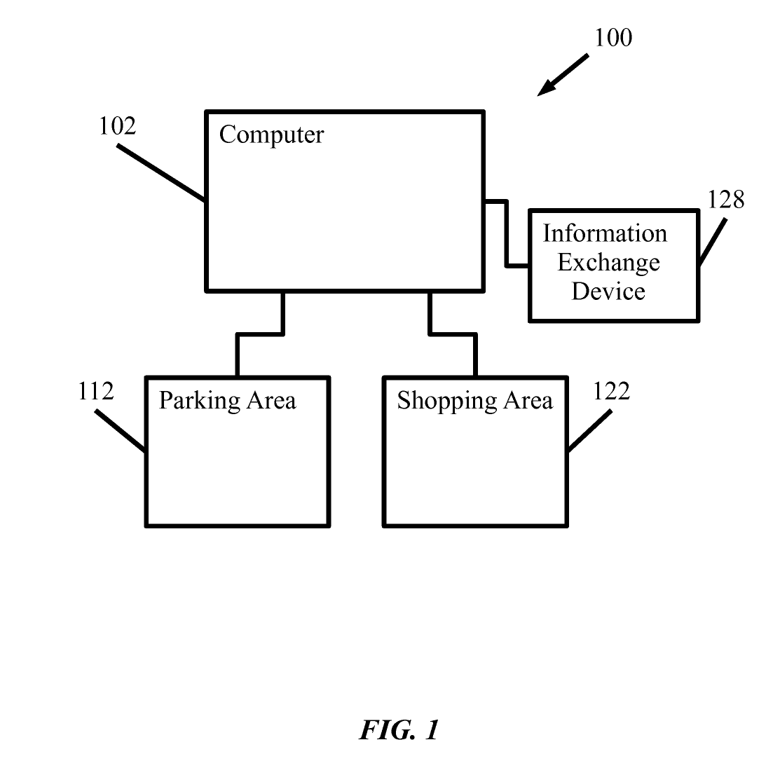

With reference to FIGS. 1-3, The system 100 includes a computer 102 having a processor 104, a memory 106, a computer application 108 having software that includes image recognition software, and a database 110 configured to store advertisement data, vendor data, consumer data including consumer profiles, and image data. The system 100 further includes a parking area 112 having portal area 114 through which vehicles may pass and a camera 116. In certain embodiments, the system 100 may also include a ticket generator 118 that issues tickets 120 that permit parking in the parking area 112, and an exit ticket reader 126 that regulates vehicles existing the parking area. Preferably the parking area 112 is located near shopping centers, malls, outlets, etc., generally referred to herein as shopping areas 122.

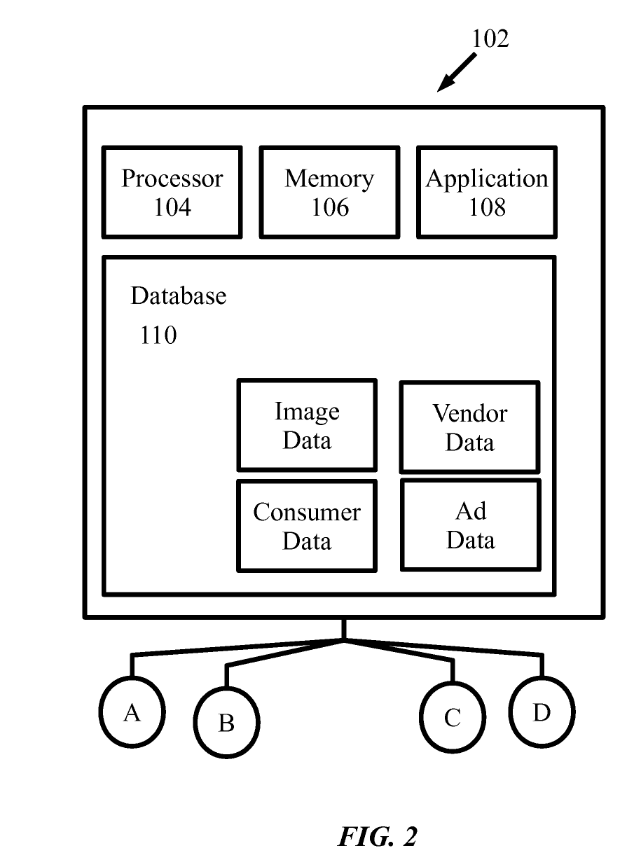

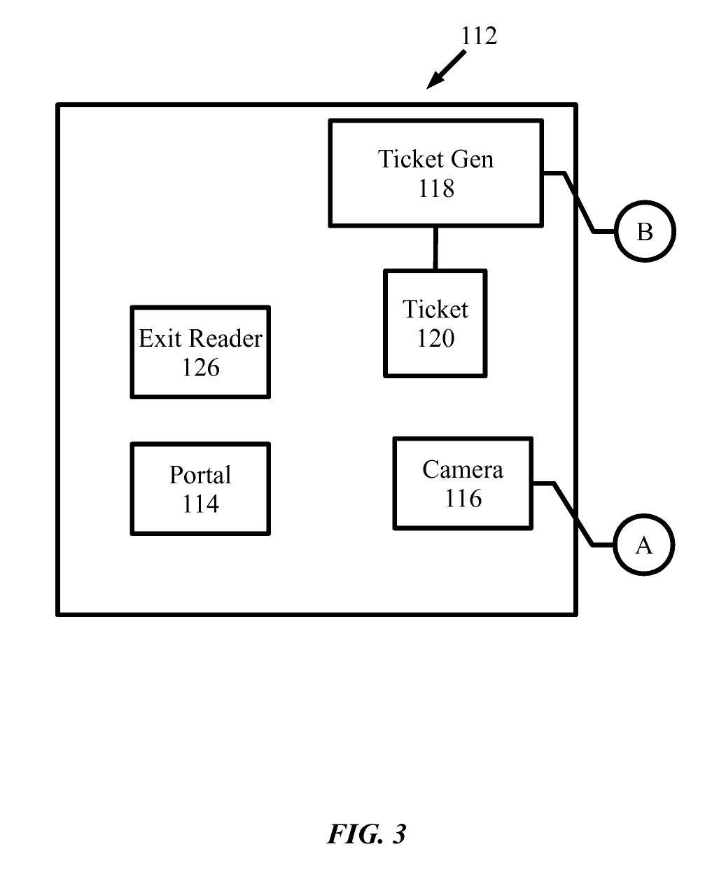

As shown in FIGS. 2 and 3, the parking area 112 includes a camera 116 that is in communication with the computer 102, which is preferably located near the portal 114. The camera 1116 is configured to capture the image data, which may include one or more of still photographs or videos. This image data may include, for example, a photo or video of the front, rear or side portion of a vehicle entering the parking area 112 or of its occupants. Preferably, this image data is created at the time of and in response to a consumer being located in the portal area 114 while entering the parking area. The image data is then communicated to the computer 102 and saved to the database 110.

The computer 102 then applies the image recognition software of the computer application 108 to obtain consumer data from the image data. The consumer data is also stored to the database. In certain preferred embodiments, the consumer data extracted from the image data includes the make and model of the vehicle. In other embodiments, the consumer data extracted from the image data includes the license plate number of the vehicle located at the portal 114. In other embodiments, the consumer data extracted from the image data includes the gender of an occupant of the vehicle located at the portal 114. The image recognition software may also identify approximate age, race, height and weight as well as other physical attributes such as hair and eye color.

Multiple cameras may be used in order to obtain multiple angles. For example, a first camera may capture the front of the vehicle, a second camera may be positioned along the side of the vehicle to take a photo of the driver's face as they take enter the parking area, and a third camera may be positioned behind the vehicle in order capture the rear of the vehicle, including the license plate number and the make and model of the vehicle. Additional cameras may also track the vehicle as it moves through the parking area in order to determine where that vehicle has parked. The computer applies the software to the image data in order to obtain consumer data, which is then stored by the computer in association with the related consumer.

Alternatively, the system 100 may request that the consumer provide their parking location to the system. This information may be provided by the consumer at parking area kiosks that may be located, for example, at each parking location or nearby such as at the end of a row of parking. Alternatively, the consumer may text this information to a particular phone number or enter the information into a mobile application interface. Providing this information may serve as a convenience function that would assist a consumer in recalling their parking location in the parking area 112. For example, upon returning to the parking area 112, a map of the parking area showing the parking location may be displayed on a mobile phone or at a kiosk.

As shown in FIG. 3, the system 100 may include a ticket generator 118 that is in communication with the computer 102 and that is preferably located near the portal areas 114. The ticket generator 118 is configured to issue a ticket 120 having a machine-readable code, such as a bar code or a QR code. The machine-readable code preferably enables the consumer to interact with one or more components of the system. In certain embodiments, the ticket 120 may include one or more advertisements in addition to the machine-readable code. The computer 102 is configured to associate ticket code data with image data that were created when the ticket 120 was issued. The ticket 120 may be a physical ticket or an electronic ticket. The consumer may be required to accept a ticket 120 before being admitted into the parking area 112. The ticket generator 118 may include an attendant or kiosk in order to accept payment and to distribute and receive tickets. Preferably, the ticket generator 118 is a fully automated computer-driven system that functions without human interaction.

In certain embodiments, the system 100 begins collecting and storing data on the consumer upon the issuance of a ticket 120. For example, the issuance of the ticket 120 causes instructions to be delivered to the computer 102 to capture image data using the camera 116. Information may be collected either passively or actively. All data collected for each consumer is stored in the database 110 and is associated with profile created for the consumer, as discussed below. Passive information is information that is collected by the system 100 and without human input. This includes, for example, any images taken automatically by the system 100 or other consumer information obtained as a result of the image recognition software. On the other hand, active information is information that is entered into the system 100 by the consumer herself or by a third party such as a vendor. This may include physical and demographic information, such as age, race, marital status, employment status, employer, fingerprints, etc. While some of this information may be obtained passively, such as through observation and educated guessing, it is preferable for the consumer herself to enter this type of information to ensure its accuracy and completeness.

At that time, the computer 102 may also generate electronic profiles for each of the consumers entering the parking area 112 through the portal 114 and be programmed to save those profiles to the database 110. Preferably, the system 100 can determine if a profile has already been created for a consumer entering the parking area 112 and no new profile is created for that consumer. In that case, the new image data is saved to the pre-existing profile.

Active information may be entered using information exchange devices 128 such as computers, kiosks, mobile devices (e.g., mobile phone and mobile tablet computer), etc. This may include, for example, purchases made by the consumer and carried out using a POS terminal 124, a particular type of information exchange device. This information may also include, for example, image data captured by the POS terminal 124, information input by the consumer directly into the POS terminal or via a mobile interacting with the POS terminal.

POS terminals 124 may provide goods or services to consumers. The goods and services offered may be specifically tailored to the consumer based on information associated with that consumer. For example, tickets to a ballet may be offered to a consumer who has shown an interest in dance in the past. Vouchers for golf lessons may be offered to a man that recently purchased golf clubs. Additionally, the POS terminal 124 may permit the man to reserve a tee time at a nearby course. The tickets, coupons, information, etc. may be delivered to the consumer in a number of different ways. For example, the POS terminal 124 may send the tickets and vouchers or directions to the course to the consumer's email address or to her smartphone.

Information exchange devices 128 may also be used by consumers for accessing, updating, or correcting their consumer profile, inputting the parking location of their vehicle, receiving advertisements or coupons, etc. For example, advertisements may be delivered to consumers via exchange devices 128 that are placed in common areas, inside store locations, etc., that are in the general vicinity of the parking areas 112 and that the consumer is likely to encounter (e.g., along the walking areas or route between the garage and intended destination). Exchange devices 128 may also provide consumers with other relevant information, such as warnings, closure notices, general vendor information, etc. Additionally, consumers may sign up for an account to use the system 100 using an information exchange device 128 before traveling to a parking area 112. Consumers may prefer to set their profile up beforehand in order to streamline the initialization process or to receive added benefits, etc.

The content displayed on exchange devices 128 may change from one consumer to the next. For example, when the device 128 detects a different consumer, either through detection using facial recognition software or through some input from the consumer, it may display information, including advertisements, relevant to that particular consumer. The content displayed would change depending on the consumer and would be specifically tailored to the consumer based on information associated with that consumer's profile. For example, if a consumer attended a ballet the previous year, an exchange device 128 may offer a discount to the current year's ballet. However, the display 128 may later display a golf-related advertisement to a different consumer based on his prior interest in golf. Additionally, the device 128 may provide information on other shows or attractions that may be of interest to the consumer, such as directions to a dance supply store.

One purpose of collecting this information is to enable the system 100 or vendors to provide advertising (e.g., promotions, discounts, etc.) that are relevant to that consumer. In particular, after relevant data has been collected and analyzed for a particular consumer, the computer 102 selects one or more advertisements based on at least a portion of the data saved to the database 110 and associated with the electronic profile for that consumer and transmits delivery commands requesting delivery of the selected advertisement to the consumer.

Using the system 100, the consumer or the consumer's behavior is analyzed to determine suitable advertisements that are likely to be relevant to that consumer. Advertisements may be associated with certain qualities or criteria that they are associated with and that may be used by the computer 102 to determine whether that particular advertisement is appropriate for a particular consumer. When consumer data is analyzed and qualities about the consumer match the qualities associated with a particular advertisement, then that advertisement is likely to be more relevant to that particular consumer than other advertisements that have fewer or no matches. For example, if the system 100 determines that the consumer is a male, it would issue a male-related advertisement, and if the consumer were female, the system would issue a female-related advertisement. In a second example, an individual who has never purchased child-related goods probably does not have children. As such, advertisements for baby supplies, such as for car seats, would likely not be relevant to them. On the other hand, these advertisements may be relevant to an individual that regularly purchases baby formula at the grocery store and has recently purchased baby toys. In another example, if the computer determines that a particular consumer is female, it may display advertisements for makeup, but would not display those advertisements if the consumer were male. In yet another example, if the computer determines that the consumer is under the legal drinking age, it may not display advertisements for alcohol-related products, but it may display those advertisements if it detects that the consumer is over the legal drinking age.

The type of information acquired by this system 100 may not be readily apparent nor can it be easily ascertained from merely observing a consumer a single time, such as during a single transaction. Nonetheless, this type of information is immensely helpful to vendors when they are attempting to target their marking efforts towards a specific demographic or group of consumers. To overcome this inherent difficulty, this is a learning system, where each consumer's profile is refined over time. Observing consumers over a period of time during a number of interactions and then cataloguing and analyzing those multiple interactions, a more complete profile of the consumer is generated. At least some of this information is readily observable but is typically not collected and stored in a single location for analysis to determine patterns or trends. Accordingly, one benefit of this system is that, as a consumer's profile becomes more detailed with the inclusion of more data, which allows more relevant advertisements and incentives to be provided to that consumer.

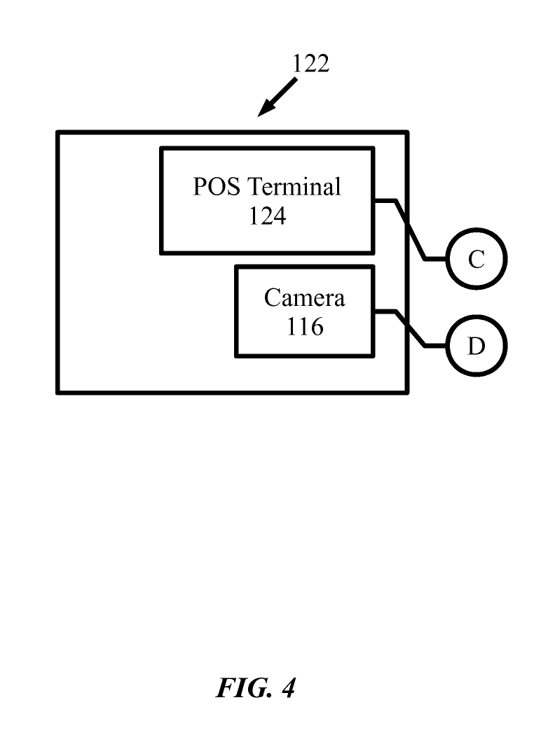

Returning to FIGS. 1-4, after the consumer enters the parking area 112 via the portal 114 and receives a ticket 120, she may then walk to a nearby shopping area 122. This shopping area 122 may include stores or other vendor locations having a POS terminal 124 in communication with the computer 102 and capable of carrying out an interaction between a consumer and a vendor. This interaction may be a commercial exchange for the sale of products or services. For example, the POS terminal 124 may be a cash register at a grocery store. In other embodiments, the POS terminal 124 is located at a vehicle drive-through area, such as at a fast food restaurant, and may be accessed by the consumer while the consumer is in their vehicle. Alternatively, this interaction may be simply an exchange of information. The POS terminal 124, therefore, may include such things as a cash register, a vending machine, an information display, or the like.

The POS terminal is preferably configured to receive consumer information from the consumer and to then communicate that information to the computer 102, which is then saved to the database 110. At that point, in response to receiving information about a consumer, the computer 102 attempts to identify the electronic profile associated with the consumer by comparing the information received with data associated with the stored electronic profiles.

In certain embodiments, the POS terminal 124 is a vendor ticket machine that is capable of reading the ticket code on the ticket 120. In other embodiments, the POS may simply be a vendor mobile device, such as a smart phone, that is configured to scan the ticket code. Preferably, a downloadable mobile application may be used to receive information related to the exchange with the consumer, either through direct input into the application or by acquiring image data using a camera located in the mobile device. This may include, for example, photographing or videoing the ticket in order to ascertain the ticket code. The information received from the vendor, therefore, may include the ticket code provided to the customer with the parking ticket 120, which may be provided in place of or in addition to other identifying information that would identify that particular customer. For example, if a customer makes a purchase with certain vendors and, during that purchase, scans her ticket or provides her ticket code, she may receive discounts on parking, coupons or other benefits.

The system 100 may also be configured to provide feedback information, such as usage statistics for coupons and promotions that are provided to consumers. This feedback information may be useful to vendors for a variety of reasons, including for example, in determining the effectiveness and reach of their marketing efforts. When the consumer utilizes the coupon or promotion at a vendor location, a promotional code may be entered into the POS terminal or a barcode may be scanned by the POS terminal. This information may also include survey data, such as from a “how did you hear about us?”-type poll. This feedback information may then be transmitted to the computer and stored in connection with the consumer's profile. This information along with other usage information or other consumer or vendor information may then be used to provide statistics, trends and other useful information to vendors.

The information provided by the consumer, along with other information (i.e., vendor data), such as the time of purchase, the date of purchase, the location of purchase, the goods or services purchased, and any additional discounts or benefits that the consumer received through their participation may be transmitted to the computer 102 and saved to the database 110 in association with the consumer's profile. At the same time, a camera 116 located near the POS terminal 124 may also capture image data of the consumer interacting with the POS terminal. This information is then added to the database 110 and is associated with that consumer in order to further build that consumer's profile.

Additionally, if a profile is lacking certain information, a notification may be sent to the vendor requesting that the missing information be obtained. For example, if the consumer's phone number is on file but their email address is not, the vendor may be prompted by the system 100 to request the consumer's email address. As another example, if the consumer has not downloaded the mobile app, the system 100 may prompt the consumer to download and install the app. Additional benefits, such as additional coupons, greater discounts, etc., may be provided to the consumer if they provide the missing information or download the app, etc.

As mentioned previously, the system 100 may include an exit ticket reader 126 that is capable of reading ticket codes and that regulates the exit of vehicles from the parking area 112. This exit ticket reader 126 may include, for example, a bar code reader or an RFID sensor. The exit reader 126 may assess a monetary fee to the consumer for their use of the parking area 112. This fee may be calculated in a number of ways including based on the amount of time between the issuance of the ticket 120 and when it was scanned at the exit reader 126, or a flat rate fee. If a fee were assessed, the vehicle would be permitted to exit the parking area 112 once the assessed fee has been paid or a sufficient number of credits have been applied.

One of the benefits that a consumer may receive through her use of this system 100 is a credit that may be applied to the assessed fee. If the consumer chooses to scan their ticket 120 or provide other identifying information at vendor locations, to information exchange devices 12 or to POS terminals 124, she may be provided with these incentives. At the exit ticket reader 126, when the consumer scans her ticket 120, the computer 102 attempts to identify the profile associated with the ticket code or with the information provided and determine if any discounts or benefits should be provided to the consumer. If no benefits are located, the consumer pays the assessed fee. This may occur, for example, if a consumer parks in the parking area 112 but does not make any purchases. On the other hand, if credits are found, the consumer may choose whether and how much credit should be applied to the assessed fee, and the consumer then pays the assessed fee minus any discounts. In this way, the system 100 encourages consumers to behave in a certain way and to make purchases with vendors while, at the same time, the costs of subsidizing parking for consumers who do not make purchases or who do no participate is reduced or eliminated.

The system 100 may also detect and prevent fraudulent behavior. For example, once a consumer has completed their purchases, received a credit from a vendor, and approaches the exit reader 126, the system 100 may conduct a validation check before applying the credit. When the consumer scans a ticket 120 at the exit reader 126, the system 100 may verify that the combination of the license plate (or other observable information) and ticket scanned are also matched in the database 110. If the information matches, the system 100 applies any desired credits and calculates the amount due. On the other hand, if the information does not match, any discounts will not be honored. For example, suppose car #1 having license plate number ‘111111’ entered a parking garage and obtained a ticket and later car #2 having license plate number ‘222222’ attempts to exit the garage with a free parking credit using car #1's ticket. In that instance, the system 100 would indicate that the license plates do not match and would decline the free parking credit and would charge car #2 for its parking.

The first steps in setting up this system 100 is to provide a suitable parking area 112 and to establish a network of subscribing vendors. The parking area 112 should preferably be located in an area that consumers are likely to park and that is configured to implement the system 100, such as near a shopping area 122 that includes shopping centers, malls, outlets, etc. so that consumers would be willing to park in the parking area 112 while they conduct their shopping.

Participating vendors would preferably pay a subscription fee to a service provider and, in exchange, that vendor would gain access to the database 110 or be permitted to place advertisements into the database. Advertisements saved to the database 110 could then be distributed to consumers in a number of ways, including automatically or on demand by the vendor. In one embodiment, advertisements may be provided to consumers randomly, when certain conditions are met (e.g., a specified amount of time since the last ad was displayed has elapsed), or on a schedule set by the vendor.

These advertisements may be displayed on an exchange device 128 that is in communication with the computer 102. This may include, for example, an electronic sign or billboard, a mobile device such as a cell phone, or a computer or television monitor. For example, the advertisements may be delivered to an email address in an email or via text message or mobile application to a mobile phone. Alternatively, the ticket itself may also be printed with one or more advertisements.

The ads displayed to a particular consumer may vary depending the data saved to the consumer's profile. For example, if a consumer's profile demonstrates a new interest in photography, such as through the purchase of a camera and lenses, advertisements for photography-related goods and services may be displayed. However, if the same consumer's behavior later indicates a lack of interest in photography and an interest in golf, fewer photography advertisements may be displayed and more golf advertisements may be displayed from time to time. In another embodiment, if a vendor is running a promotion, such as a clearance sale, the vendor may send advertisements, including flyers, coupons, etc., to consumers on demand. In certain embodiments, the system 100 may provide vendors with access to the database 110 and permit them to search for potential customers based on information stored to that database. Vendors may use this ability to formulate a marketing strategy for a particular demographic or to send advertisements to select customers. For example, a vendor may search for consumers that have spent over a certain dollar amount within a given time frame. In another example, a vendor may search for consumers that have purchased a competitor's product and send advertisements to those consumers for their own products.

In certain embodiments, the system 100 is able recognize and interact with consumer's electronic devices, such as smartphones, tablets, etc. automatically. This may be accomplished through communications network, such as the Internet, or proximity-based sensing, such as sensing a Wi-Fi signal from these devices; a Bluetooth signal; or a cellular signal from the electronic devices, or other similar network connections. Preferably, the network connection comprises an open signal that can be detected automatically by the system 100 without the need for credentials, such as a user name and password. Once the system 100 detects the presence of a nearby device, it may automatically send a request to the consumer 100 for access.

If access is granted, the system 100 may automatically send requests or messages, or information or advertisements to the consumer via the device. For example, the system 100 may request the consumer to download a mobile app to the device that works cooperatively with the system and provides additional features to the consumer when using the system. Preferably, this request can be sent to the consumer automatically, without credentials such as a cell phone number. If access is granted in response to the request and the app is downloaded and installed, it preferably runs in the background of the device at all times. With the app running, it may collect further information about the consumer by accessing that consumer's social media connections, such as its Facebook, Twitter and LinkedIn information.

Additionally, the system 100 can preferably identify, through proximity-based sensing, when the device is near a component of the system and to interact with the system. For example, with the app running, various components in the parking are 112 may be able to sense the presence of the device and to take some action in response to its presence, including determining the correct fee for exiting the parking area 112. In another example, with the app running, an information exchange device 128 may detect that the consumer's device and display an advertisement or a greeting specific to that consumer. Also, a POS terminal 124, such as a cash register or vending machine, could recognize that the device is nearby and provide information to the vendor or provide benefits, such as discounts, to the consumer.

The consumer may be asked to provide personal or financial information in order to gain access to additional convenience features of the system 100. This information may include financial account or credit card information, social media login credentials (e.g., Facebook, LinkedIn, Google Plus, etc.), etc. If a consumer has provided financial information, such as information for their PayPal, credit card, or other financial accounts, the system 100 would preferably permit consumers to make and pay for purchases through the system using this saved financial information.

For example, if a POS terminal 124 detects a consumer who has set up and saved financial information with the system 100, it may permit that consumer to pay for their purchases automatically using one of those financial accounts. Preferably, if financial information has been provided, the system 100 will include security features to help in preventing fraudulent or unwanted expenditures. For example, a payment confirmation and a password entry may be required if a purchase is made using the system 100. This feature would benefit consumers and vendors because of reduced wait times at checkout and reduced staffing needs. Additionally, this embodiment could provide a financial benefit to a service provider. For example, if purchases are made using the mobile application, the service provider may receive a portion of the purchase price or a fee, much like credit card providers, for the convenience of using the system 100.

Once payment through the app has been authorized by the consumer, confirmation of such payment may be sent to a system component (e.g., POS terminal, etc.). For example, if this feature was used in a store to purchase ice cream, the consumer would pay for the ice cream using the app, confirmation would be sent to a nearby POS terminal or printer, which would then deliver a receipt to the consumer. In another example, as a consumer leaves the parking area 112 and a balance is due, the app would ask whether the consumer wished to pay for his parking using the app. If the consumer agrees, a confirmation of such payment would be sent to the exit reader 126 and the consumer would be permitted to exit the parking area 112. In another example, if a consumer is in a drive-thru line for a fast food restaurant, the menu board or a POS terminal located nearby may recognize the presence of a consumer's device having the mobile app and permit the consumer to purchase his food using the app.

In carrying out these types of purchases, the system 100 may be configured to automatically send a message or a push notification to alert the consumer that the system components have detected and linked to their mobile device and to ask the consumer if they would like to make their purchases using the mobile application. If the consumer declines to use the system 100 to pay for his purchases using the application or has not provided financial information, they may pay using conventional methods, such as cash or credit cards. One benefit of this system 100 is that, even if the consumer declines to purchase items through the application, those purchases may still be sent to the database 110 and associated with that consumer's profile. This type of documentation assists in providing a more complete, up-to-date profile, which allows vendors to provide the consumer with better and more relevant advertisements.

This system 100 may be configured to benefit vendors even if they are not located near a controlled parking area 112 by providing these vendors with access to the database 110. For example, if a vendor is part of the network of subscribers, they may be permitted to access the database 110 and place their advertisements into the database 110, which may then be sent to consumers. For example, if potential consumer arrives at a vendor's unsecured parking lot (i.e., not a controlled parking area), the system 100 may allow the vendor to gain insight on that consume, including his or her needs and purchasing habits.

In order to identify the consumer, the vendor may submit a photo of the consumer or the consumer's vehicle or other identifying information obtained by the vendor, such as the consumer's name or email address. If that consumer has previously visited a controlled parking area and a profile has been set up for that consumer, the vendor could log in and review the information stored to the consumer's profile. The profile may show what other types of products the potential consumer has recently purchased and make recommendations that are appropriate to that consumer's style or needs.

In another example, the vendor may wish to provide coupons or provide other types of promotions or advertisements to a particular sub-set of consumers. In that case, the vendor would upload the advertisements to the database 110 and then define the population or type of customer that should receive the advertisement. The vendor may be charged for each consumer that the advertisement is sent to. So, they may wish to narrowly define that population.

By using this system 100, vendors would be able to define exactly what parameters their customers should have and what characteristics appropriate recipients for their advertisements should have. Typically, uncovering this type of information is often time consuming and expensive for vendors. For that reason, vendors often use a “shotgun” approach to advertisement where the advertisements are provided to everyone. This system 100 permits a more targeted approach by allowing vendors to direct ads to only those consumers that are most likely to shop with them. Therefore, having quick access to this type of information through this system 100 and would potentially provide cost savings and increased revenue to vendors.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A computer-implemented system for generating advertisements based on data, the system comprising:
a computer comprising a data processor, a memory, a computer application including image recognition software, and a database configured to store advertisement data, vendor data, consumer data, and image data;
a parking area comprising a portal through which vehicles may pass and a first camera located proximate the portal configured to capture image data including one or more of still photographs or videos, the image data being created at the time of and in response to vehicles being disposed in the portal, the first camera being further configured to communicate the image data to the computer;
a ticket generator configured to issue a ticket having a machine-readable code to a parking area consumer located at the portal and to communicate each ticket code to the computer, the computer being configured to associate the ticket code with image data that were created when the ticket was issued;
the computer being configured to generate an electronic profile associated with the parking area consumer and to store to the profile to the database, and to apply the image recognition software to the image data to obtain consumer data for the parking area consumer and to store the consumer data to the electronic profile associated with the parking area consumer and the ticket code on the ticket issued to the parking area consumer; and
the computer being further configured to select one of a plurality of advertisements based on data associated with the electronic profile for the parking area consumer and to transmit delivery commands requesting delivery of the selected advertisement to the parking area consumer.

2. The computer-implemented system of claim 1 further comprising a point-of-sale (POS) terminal in communication with the computer operable for carrying out an interaction between a consumer and a vendor, the POS terminal configured to receive consumer information from the parking area consumer and to communicate that consumer information to the computer, the computer configured to identify the electronic profile associated with the parking area consumer by comparing the consumer information received from the parking area consumer with data associated with the electronic profiles, the POS terminal further configured to communicate vendor data to the computer at the time of the interaction with the parking area consumer, wherein the computer then associates the vendor data received with the identified profile.

3. The computer-implemented system of claim 2, wherein the POS terminal comprises a vendor ticket machine programmed to read the code on a ticket and wherein the consumer information communicated by the POS terminal to the computer comprises the ticket code.

4. The computer-implemented system of claim 2 further comprising an exit ticket reader and a fee-based exit control device located at the portal of the parking area, the control device operable for regulating the exit of vehicles from the parking area, for assessing a fee in response to a ticket being scanned at the exit ticket reader, and for permitting the vehicle to exit the parking area in response to receiving payment of the assessed fee.

5. The computer-implemented system of claim 4, wherein the vendor data comprises a credit to reduce the parking fee that is associated with the selected profile, wherein when the consumer scans the ticket at the exit ticket reader the computer applies the credit to reduce the parking fee by sending instructions to the fee-based exit control device to permit the vehicle to exit the parking area after receiving payment of a reduced fee.

6. The computer-implemented system of claim 5 wherein the consumer may optionally select to apply at least a portion of the credit and to pay a reduced fee or to not apply the credit and pay the assessed fee.

7. The computer-implemented system of claim 2, wherein the vendor data comprises at least one of a description of the items purchased by the consumer using the POS terminal, the time of the purchase, the date of the purchase, and the purchase price.

8. The computer-implemented system of claim 2 wherein the POS terminal is located at a vehicle drive-through area and may be accessed by the parking area consumer from a vehicle located in the drive-through area.

9. The computer-implemented system of claim 2 further comprising a second camera located proximate the POS terminal that is configured to capture image data, the image data created at the time of and in response to a consumer accessing the POS terminal, the second camera being further configured to communicate the image data to the computer and wherein the application applies the image recognition software to the image data to obtain consumer data and the computer compares that consumer data with consumer data stored in the computer to identify the consumer.

10. The computer-implemented system of claim 1 wherein the consumer data comprises the make and model of a vehicle located at the portal.

11. The computer-implemented system of claim 1 wherein the consumer data comprises the license plate number of the vehicle located at the portal.

12. The computer-implemented system of claim 1 wherein the consumer data comprises the gender of an occupant of the vehicle located at the portal.

13. The computer-implemented system of claim 1 wherein the consumer data comprises the identity of an occupant of the vehicle located at the portal.

14. The computer-implemented system of claim 1 further comprising a third camera located proximate the portal configured to capture image data, the image data being created at the time of and in response to vehicles being disposed in the portal of the parking area, the third camera being further configured to communicate the image data to the computer, wherein the application applies the image recognition software to the image data to obtain consumer data, and stores the consumer data to the electronic profiles in association with the consumers and the ticket codes, wherein the consumer data obtained from the third camera is different from the consumer data obtained from the image data of the first camera.

15. The computer-implemented system of claim 1, further comprising a display screen for displaying the selected advertisement.

16. The computer-implemented system of claim 1 further comprising a mobile device selected from the group consisting of a mobile computer, a mobile tablet, and a mobile phone, the mobile device including an application enabling the mobile device to communicate with the computer and to transmit consumer data to the computer, the mobile device also including a display screen for receiving the delivery commands and for delivering the selected advertisement to the parking area consumer.

17. The computer-implemented system of claim 1, wherein the ticket comprises one or more advertisements.

18. A computer-implemented method for generating advertisements based on data, the method comprising the steps of:
providing a computer that comprises a data processor; a memory; a computer application for providing instructions to the computer, the application including image recognition software; and a database containing advertisement data, vendor data, consumer data, and image data, all stored to the memory;
providing a parking area that comprises a portal through which vehicles may pass and a first camera located proximate the portal configured to capture image data including one or more of still photographs or videos;
issuing a ticket having a machine-readable code from a ticket generator to the parking area consumer located in the portal;
capturing image data of the parking area consumer located in the portal at the time of and in response to a parking area consumer being disposed in the portal and retrieving a ticket from the ticket generator communicating the image data from the first camera to the computer;
communicating the ticket code from the ticket generator to the computer;
providing instructions to the computer to associate the ticket code received with the image data that were created when the ticket was issued;
providing instructions to the computer to create an electronic profile associated with the parking area consumer and to store the profile in the database;
providing instructions to the computer to apply the image recognition software to the image data to obtain consumer data and to store the consumer data to the electronic profile;
providing instructions to the computer to select one of a plurality of advertisements based on data associated with the electronic profile and to transmit delivery commands requesting delivery of the selected advertisement to the consumer.
